(19) United States
(12) Patent Application Publication
(10) Pub. No.: US 2009/0149201 A1
(43) Pub. Date: Jun. 11, 2009

(54) Apparatus and method for providing position information of wireless terminal

(75) Inventors: Hee-seob Ryu, Suwon-si (KR); Ho-joon Yoo, Seoul (KR); Yeun-bae Kim, Seongnam-si (KR); Sang-on Choi, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/076,779

(22) Filed: Mar. 21, 2008

(30) Foreign Application Priority Data
Dec. 5, 2007 (KR) 10-2007-0125675

(51) Int. Cl. H04Q 7/20

(52) U.S. Cl. 455/456.6

(57) ABSTRACT

An apparatus and method for providing position information of a wireless terminal are provided. The apparatus map-matches a position estimated using a wireless signal received from a satellite or a base station to output the map-matched result when a reception state of the wireless signal is good, and map-matches a position detected by dead reckoning to output the map-matched result when the reception state of the wireless signal is not good, thereby enabling a user to correctly detect the position of the wireless terminal regardless of the reception state of the wireless signal received from the satellite or the base station.

### CROSS REFERENCE TO RELATED APPLICATIONS

This application claims priority from Korean Patent Application No. 10-2007-0125675, filed on Dec. 5, 2007, the disclosure of which is incorporated herein in its entirety by reference.

### BACKGROUND OF THE INVENTION

1. Field of the Invention

The present invention relates to a technology for providing position information of a wireless terminal, and more particularly, to an apparatus and method for providing position information of a wireless terminal, by map-matching a position of a wireless terminal using different wireless-terminal positioning methods according to a reception state of a wireless signal received from a satellite or a base station.

2. Description of the Related Art

A navigation system detects a position of a vehicle or pedestrian on a path and provides the position information to the vehicle driver or pedestrian. Such a position of the vehicle or pedestrian can be detected by a positioning method using a satellite navigation system or a base station.

The positioning method using a satellite navigation system, such as Global Positioning System (GPS), Galileo, GLONASS, etc., estimates a position of a receiver using wireless signals received from a plurality of satellites positioned in orbit above the earth.

Meanwhile, the positioning method using a mobile communication base station, a Digital Multimedia Broadcasting (DMB) base station, etc., estimates a position of a receiver using a previously known position of the base station, a receiving time of a wireless signal, intensity of the received wireless signal, and so on.

However, the wireless signal transmitted from the satellite or base station may be blocked or reflected at a region, e.g., a tunnel or a high building, in which a receiver cannot normally receive the wireless signal. Thus, the wireless signal transmitted from the satellite or base station may be distorted and then received by the receiver.

Consequently, it is impossible to correctly detect the position of the wireless terminal.

### SUMMARY OF THE INVENTION

The present invention provides an apparatus and method for providing position information of a wireless terminal which correctly detect a position of the wireless terminal regardless of a reception state of a wireless signal received from a satellite or a base station.

To this end, the present invention proposes an apparatus and method for providing position information of a wireless terminal by map-matching a position estimated using a wireless signal received from a satellite or a base station to output the map-matched result when a reception state of the wireless signal is good, and by map-matching a position detected by dead reckoning to output the map-matched result when the state of the wireless signal is not good.

Additional aspects of the invention will be set forth in the description which follows, and in part will be apparent from the description, or may be learned by practice of the invention.

The present invention discloses an apparatus for providing position information of a wireless terminal, including: a signal receiver for estimating a position of the wireless terminal using a wireless signal received from a satellite or a base station; a sensor for detecting a position of the wireless terminal using dead reckoning; and a controller for determining whether or not a reception state of the wireless signal is good using the position estimated by the signal receiver, map-matching the position estimated by the signal receiver when the reception state is good, and map-matching the position detected by the sensor when the reception state is not good.

The controller may determine whether or not the reception state is good using attribute information corresponding to the position estimated by the signal receiver among previously stored digital map information. Here, the attribute information may be information on a region in which traveling or walking is possible.

Thus, the controller may determine that the reception state is good when an attribute of the position estimated by the signal receiver corresponds to the region in which traveling or walking is possible, and determine that the reception state is not good when the attribute of the position estimated by the signal receiver does not correspond to the region in which traveling or walking is possible.

In addition, the controller may determine whether or not the reception state is good using node link information corresponding to the position estimated by the signal receiver among previously stored digital map information. Here, the controller may reflect lane width information and/or wireless signal error information in the node link information to calculate a region in which traveling or walking is possible, and determine whether or not the reception state is good using the calculated region in which traveling or walking is possible.

Furthermore, the controller may determine that the reception state is good when the position estimated by the signal receiver is included in the calculated region in which traveling or walking is possible, and determine that the reception state is not good when the position estimated by the signal receiver is not included in the calculated region in which traveling or walking is possible.

The present invention also discloses a method of providing position information of a wireless terminal, including: estimating a position of the wireless terminal using a wireless signal received from a satellite or a base station; detecting a position of the wireless terminal using dead reckoning; determining whether or not a reception state of the wireless signal is good using the estimated position; and map-matching the estimated position when the reception state is good, and map-matching the position detected by dead reckoning when the reception state is not good.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of an apparatus for providing position information of a wireless terminal according to an exemplary embodiment of the present invention.

FIG. 2 is a flowchart illustrating a method of providing position information of a wireless terminal according to an exemplary embodiment of the present invention.

FIG. 3 is a flowchart illustrating a method of determining whether or not a reception state of a wireless signal is good according to an exemplary embodiment of the present invention.

FIG. 4 is a flowchart illustrating a method of determining whether or not a reception state of a wireless signal is good according to another exemplary embodiment of the present invention.

FIGS. 5A and 5B are tables illustrating attribute information of a digital map according to an exemplary embodiment of the present invention.

FIG. 6 illustrates an example of node link information of a digital map according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, like reference numerals in the drawings denote like elements. Terms are used below in consideration of their functions in the present invention but may be changed according to intention or custom of a user or administrator. Therefore, the terms should be defined on the basis of the overall specification.

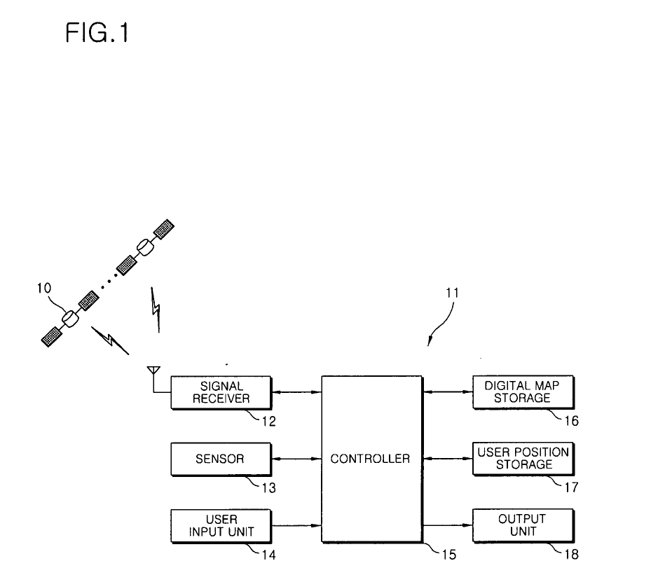

FIG. 1 is a block diagram of an apparatus for providing position information of a wireless terminal according to an exemplary embodiment of the present invention.

As illustrated in FIG. 1, an apparatus 11 for providing position information of a wireless terminal includes a signal receiver 12, a sensor 13 and a controller 15.

The signal receiver 12 estimates a position of a wireless terminal using a wireless signal received from a satellite 10 or a base station (not shown in the drawing). More specifically, the signal receiver 12 detects a distance between the satellite 10 and the wireless terminal and a position vector of the satellite 10 using a wireless signal received from a plurality of satellites 10 positioned in specific orbit above the earth. Then, the signal receiver 12 may estimate the position of the wireless terminal using the detected distance between the satellite 10 and the wireless terminal and the detected position vector of the satellite 10. Otherwise, the signal receiver 12 may measure at least one of intensity, direction and receiving time of the wireless signal received from the base station to estimate the position of the wireless terminal.

The sensor 13 detects the position of the wireless terminal using dead reckoning. More specifically, the sensor 13 sets as an initial position a final position of the wireless terminal detected when a state of the wireless signal received from the satellite 10 or the base station is good. The sensor 13 measures a moving direction and distance of the wireless terminal from the set initial position using an acceleration sensor, a terrestrial magnetism sensor, etc., and detects the position of the wireless terminal using the measured moving direction and distance. Therefore, it is possible to correctly detect the position of the wireless terminal using dead reckoning performed by the sensor 13 even when a wireless signal is distorted and then received from the satellite 10 or the base station.

The controller 15 determines whether or not the reception state of the wireless signal is good using the position estimated by the signal receiver 12. The controller 15 map-matches the position estimated by the signal receiver 12 when the reception state is good, and map-matches the position detected by the sensor 13 when the reception state is not good.

Here, the controller 15 may determine whether or not the reception state is good using attribute information or node link information among digital map information stored in a digital map storage 16. The determination on whether or not the reception state is good, the attribute information, and the node link information will be described below.

Meanwhile, the above-described apparatus for providing position information of a wireless terminal according to an exemplary embodiment of the present invention further includes a user input unit 14, the digital map storage 16, a user position storage 17 and an output unit 18.

The user input unit 14 receives information on a destination and a route by means of speech, text, etc., from a user. The destination and route information is used for guiding a traveling or walking route.

The digital map storage 16 stores digital map information. The digital map information includes an image, attribute information and node link information of a digital map. Here, the attribute information may correspond to position coordinates on the digital map, and may include, for example, a building, a vehicle road, a railroad, a tunnel, a swimming beach, a fishery, a fishing place, and so on. The attribute information may indicate whether the position coordinates on a digital map correspond to a region in which traveling or walking is possible. Examples of the attribute information will be described below. The node link information expresses the digital map using a node and a link. Examples of the node link information will also be described below.

The user position storage 17 stores the position of the wireless terminal estimated using the wireless signal received from the satellite 10 or the base station, the position of the wireless terminal detected by the sensor 13 using dead reckoning, and information about whether or not the reception state of the wireless signal is good at the detected position of the wireless terminal.

The output unit 18 outputs the result map-matched by the controller 15 on a screen of a display.

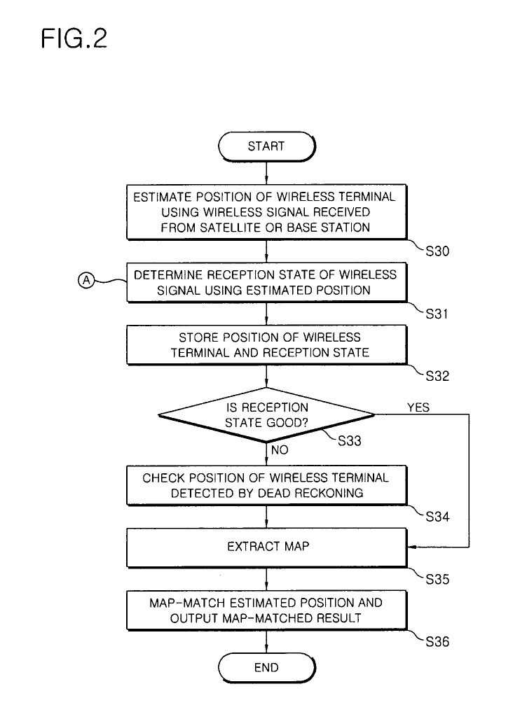

Operation of the above-described apparatus for providing position information of a wireless terminal according to an exemplary embodiment of the present invention will now be described with reference to FIGS. 2 to 6.

FIG. 2 is a flowchart illustrating a method of providing position information performed in a wireless terminal according to an exemplary embodiment of the present invention. As illustrated in FIG. 2, the method of providing position information of a wireless terminal according to an exemplary embodiment of the present invention includes estimating a position of the wireless terminal using a wireless signal received from a satellite or a base station, determining whether or not a reception state of the wireless signal is good using the estimated position, map-matching the estimated position when the reception state is good, and map-matching a position of the wireless terminal detected by dead reckoning when the reception state is not good.

The signal receiver 12 estimates the position of the wireless terminal using the wireless signal received from the satellite 10 or the base station, and the sensor 13 detects the position of the wireless terminal using dead reckoning (S30).

More specifically, the signal receiver 12 detects a distance between the satellite 10 and the wireless terminal and a position vector of the satellite 10 using a wireless signal received from a plurality of satellites 10 positioned in specific orbit above the earth. Then, the signal receiver 12 may estimate the position of the wireless terminal using the detected distance between the satellite 10 and the wireless terminal and the detected position vector of the satellite 10. Otherwise, the signal receiver 12 may measure at least one of intensity, direction and receiving time of the wireless signal received from the base station to estimate the position of the wireless terminal.

Meanwhile, the sensor 13 sets as an initial position a final position of the wireless terminal detected when a state of the wireless signal received from the satellite 10 or the base station is good. The sensor 13 measures a moving direction and distance of the wireless terminal from the set initial position using an acceleration sensor, a terrestrial magnetism sensor, etc., and detects the position of the wireless terminal using the measured moving direction and distance.

Subsequently, the controller 15 determines whether or not the reception state of the wireless signal is good using the position estimated by the signal receiver 12 (S31). Here, whether or not the reception state of the wireless signal is good may be determined using attribute information or node link information among digital map information stored in the digital map storage 16.

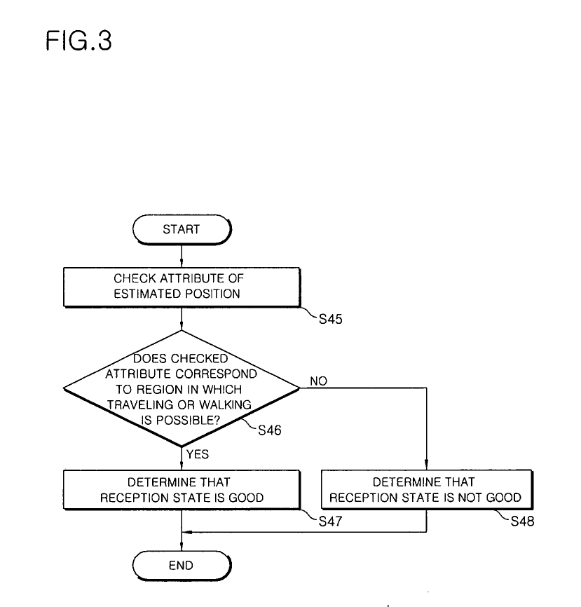

A method of determining whether or not the reception state of the wireless signal is good using attribute information according to an exemplary embodiment of the present invention will be described with reference to FIG. 3.

As illustrated in FIG. 3, the controller 15 checks an attribute corresponding to the position estimated by the signal receiver 12 using attribute information of a digital map stored in the digital map storage 16 (S45). Here, the attribute information of the digital map may correspond to position coordinates on the digital map. In addition, the attribute information of the digital map may indicate whether the position coordinates on the digital map correspond to a region in which traveling or walking is possible.

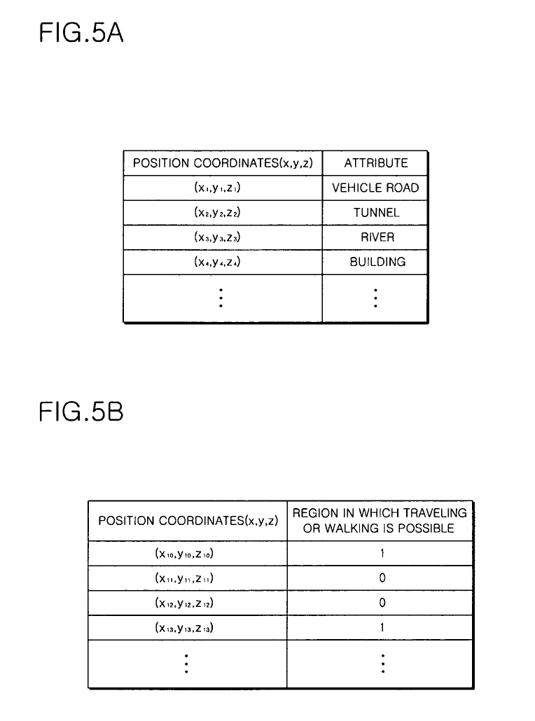

Examples of the attribute information of the digital map are shown in FIGS. 5A and 5B.

FIG. 5A is a table illustrating attributes corresponding to position coordinates on a digital map. (x, y) coordinates of position coordinates (x, y, z) on the digital map indicate a plane position, and a z coordinate indicates a vertical position.

Referring to the table of FIG. 5A, position coordinates (x₁, y₁, z₁) correspond to an attribute “vehicle road”, position coordinates (x₂, y₂, z₂) correspond to an attribute “tunnel”, position coordinates (x₃, y₃, z₃) correspond to an attribute “river”, and position coordinates (x₄, y₄, z₄) correspond to an attribute “building”. For example, when a position estimated by the signal receiver 12 is (x₁, y₁, z₁), the controller 15 determines that the attribute of the estimated position is “vehicle road”.

Meanwhile, FIG. 5B is a table illustrating whether or not position coordinates on a digital map correspond to a region in which traveling or walking is possible. (x, y) coordinates of position coordinates (x, y, z) on the digital map indicate a plane position, and a z coordinate indicates a vertical position. In addition, “1” indicates a region in which traveling or walking is possible, and “0” indicates a region in which traveling or walking is not possible. These are only examples and may be set vice versa.

Referring to the table of FIG. 5B, position coordinates (x₁₀, y₁₀, z₁₀) correspond to an attribute indicating a region in which traveling or walking is possible, position coordinates (x₁₁, y₁₁, z₁₁) correspond to an attribute indicating a region in which traveling or walking is not possible, position coordinates (x₁₂, y₁₂, z₁₂) correspond to an attribute indicating a region in which traveling or walking is not possible, and position coordinates (x₁₃, y₁₃, z₁₃) correspond to an attribute indicating a region in which traveling or walking is possible. For example, when a position estimated by the signal receiver 12 is (x₁₀, y₁₀, z₁₀), the controller 15 determines that the estimated position is a region in which traveling or walking is possible.

When the attribute corresponding to the position estimated by the signal receiver 12 is checked using the tables shown in FIGS. 5A and 5B, the controller 15 determines whether the checked attribute corresponds to a region in which traveling or walking is possible (S46). Typical examples of the attribute corresponding to a region in which traveling is possible are a vehicle road, a highway, etc., and those of the attribute corresponding to a region in which walking is possible are a pedestrian road, etc. Needless to say, the present invention is not limited to these examples.

When the attribute of the estimated position corresponds to a region in which traveling or walking is possible, the controller 15 determines that the reception state of the wireless signal received from the satellite 10 or the base station is good (S47). On the other hand, when the attribute of the estimated position does not correspond to a region in which traveling or walking is possible, the controller 15 determines that the reception state of the wireless signal received from the satellite 10 or the base station is not good (S48).

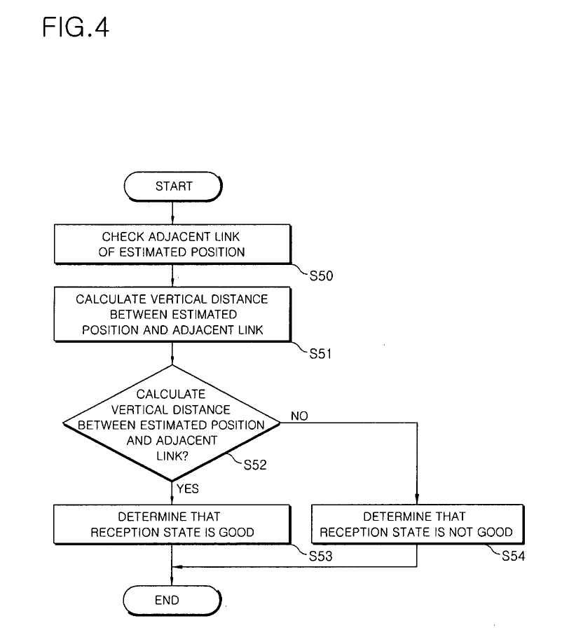

A method of determining whether or not the reception state of the wireless signal is good using node link information according to another exemplary embodiment of the present invention will now be described with reference to FIG. 4.

As illustrated in FIG. 4, the controller 15 checks a link adjacent to the position estimated by the signal receiver 12 using the node link information stored in the digital map storage 16 (S50). Here, the node link information expresses the digital map using a node and a link.

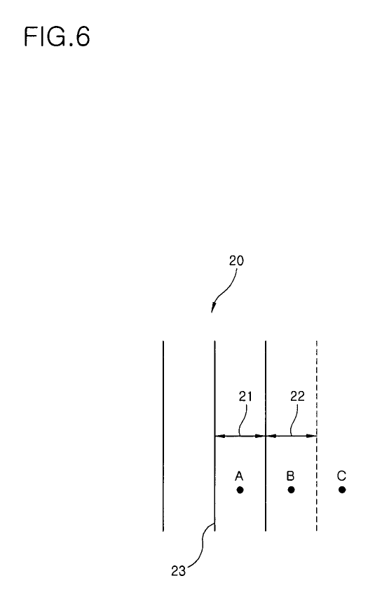

An example of the node link information is shown in FIG. 6. As illustrated in FIG. 6, a link 23 exists in the middle of a vehicle road 20, and a lane width 21 of the vehicle road 20 has a uniform distance from the link 23. In addition to this, the node link information may further include wireless signal error information. Here, the wireless signal error information denotes an error range of a position estimated according to a wireless signal received from a satellite or a base station that a wireless terminal can allow, and may be changed according to the configuration of the wireless terminal.

The controller 15 calculates a vertical distance between the estimated position and the checked link (S51), and determines whether the calculated vertical distance is within a region in which traveling or walking is possible (S52). Here, the region in which traveling or walking is possible denotes a region positioned within a specific distance from the link, and may further include a region corresponding to the wireless signal error information. Referring to FIG. 6, a region in which traveling or walking is possible may include the lane width 21 of the vehicle road 20 and a region 22 corresponding to the wireless signal error information.

When the calculated vertical distance is within the region in which traveling or walking is possible, the controller 15 determines that the reception state of the wireless signal received from the satellite 12 or the base station is good (S53). Referring to FIG. 6, when the positions of the calculated vertical distance is “A” positioned within the lane width 21 and “B” positioned within the region 22 corresponding to the wireless signal error information, it is determined that the reception state of the wireless signal received from the satellite or the base station is good.

On the other hand, when the calculated vertical distance is out of the region in which traveling or walking is possible, the controller 15 determines that the reception state of the wireless signal received from the satellite 12 or the base station is not good (S54). Referring to FIG. 6, when the position of the calculated vertical distance is “C” positioned out of the region 22 corresponding to the wireless signal error information, it is determined that the reception state of the wireless signal received from the satellite or the base station is not good.

After determining whether or not the reception state of the wireless signal is good, the controller 15 stores the position of the wireless terminal estimated by the signal receiver 12, the position of the wireless terminal detected by the sensor 13, and information about whether or not the reception state of the wireless signal received from the satellite 10 or the base station is good, in the user position storage 17 (S32).

Subsequently, the controller 15 checks the information about whether the reception state of the wireless signal is good stored in the user position storage 17 (S33). When it is confirmed that the reception state of the wireless signal is good, the controller 15 extracts a digital map image corresponding to the position estimated using the wireless signal received from the satellite 10 or the base station from the digital map storage 16 (S35). The output unit 18 matches the estimated position with the extracted digital map image and then outputs the map-matched result to the display (S36).

On the other hand, when it is confirmed that the reception state of the wireless signal is not good, the controller 15 checks the position of the wireless terminal detected by dead reckoning (S34). The controller 15 extracts a digital map image corresponding to the position of the wireless terminal detected by dead reckoning from the digital map storage 16 (S35). The output unit 18 matches the detected position of the wireless terminal with the extracted digital map image and then outputs the map-matched result to the display (S36).

As apparent from the above description, an apparatus and method for providing position information of a wireless terminal according to an exemplary embodiment of the present invention map-match a position estimated using a wireless signal received from a satellite or a base station to output the map-matched result when a reception state of the wireless signal is good, and map-match a position detected by dead reckoning to output the map-matched result when the reception state of the wireless signal is not good, thereby enabling a user to correctly detect the position of the wireless terminal regardless of the reception state of the wireless signal received from the satellite or the base station.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An apparatus for providing position information of a wireless terminal, comprising:
a signal receiver for estimating a position of the wireless terminal using a wireless signal received from a satellite or a base station;
a sensor for detecting a position of the wireless terminal using dead reckoning; and
a controller for determining whether or not a reception state of the wireless signal is good using the position estimated by the signal receiver, map-matching the position estimated by the signal receiver when the reception state is good, and map-matching the position detected by the sensor when the reception state is not good.

2. The apparatus of claim 1, wherein the controller determines whether or not the reception state is good using attribute information corresponding to the position estimated by the signal receiver among previously stored digital map information.

3. The apparatus of claim 2, wherein the attribute information is information on a region in which traveling or walking is possible.

4. The apparatus of claim 3, wherein the controller determines that the reception state is good when an attribute of the position estimated by the signal receiver corresponds to the region in which traveling or walking is possible, and determines that the reception state is not good when the attribute corresponding to the position estimated by the signal receiver does not correspond to the region in which traveling or walking is possible.

5. The apparatus of claim 1, wherein the controller determines whether or not the reception state is good using node link information corresponding to the position estimated by the signal receiver among previously stored digital map information.

6. The apparatus of claim 5, wherein the controller reflects at least one of lane width information and wireless signal error information in the node link information to calculate a region in which traveling or walking is possible, and determines whether or not the reception state is good using the calculated region in which traveling or walking is possible.

7. The apparatus of claim 6, wherein the controller determines that the reception state is good when the position estimated by the signal receiver is included in the calculated region in which traveling or walking is possible, and determines that the reception state is not good when the position estimated by the signal receiver is not included in the calculated region in which traveling or walking is possible.

8. The apparatus of claim 1, further comprising:
an output unit for outputting the map-matched result to a display.

9. A method of providing position information of a wireless terminal, comprising:
estimating a position of the wireless terminal using a wireless signal received from a satellite or a base station;
detecting a position of the wireless terminal using dead reckoning;
determining whether or not a reception state of the wireless signal is good using the estimated position; and
map-matching the estimated position when the reception state is good, and map-matching the position detected by dead reckoning when the reception state is not good.

10. The method of claim 9, wherein the determining of whether or not the reception state is good comprises determining whether or not the reception state is good using attribute information corresponding to the estimated position among previously stored digital map information.

11. The method of claim 10, wherein the attribute information is information on a region in which traveling or walking is possible.

12. The method of claim 11, wherein the determining of whether or not the reception state is good comprises determining that the reception state is good when an attribute corresponding to the estimated position corresponds to the region in which traveling or walking is possible, and determining that the reception state is not good when the attribute corresponding to the estimated position does not correspond to the region in which traveling or walking is possible.

13. The method of claim 9, wherein the determining of whether or not the reception state is good comprises determining whether or not the reception state is good using node link information corresponding to the estimated position among previously stored digital map information.

14. The method of claim 13, wherein the determining of whether or not the reception state is good comprises reflecting at lest one of lane width information and wireless signal error information in the node link information to calculate a region in which traveling or walking is possible, and determining whether or not the reception state is good using the calculated region in which traveling or walking is possible.

15. The method of claim 14, wherein the determining of whether or not the reception state is good comprises determining that the reception state is good when the estimated position is included in the calculated region in which traveling or walking is possible, and determining that the reception state is not good when the estimated position is not included in the calculated region in which traveling or walking is possible.

16. The method of claim 9, further comprising:
outputting the map-matched result to a display.
